(19) United States
(12) Patent Application Publication
(10) Pub. No.: US 2009/0056819 A1
(43) Pub. Date: Mar. 5, 2009

(54) MIXING VALVE

(75) Inventor: Eric Winter, Evesham (GB)

Correspondence Address: WILMERHALE/NEW YORK, 399 PARK AVENUE, NEW YORK, NY, 10022, US

(73) Assignee: LIANCE WATER CONTROLS LIMITED, Worcestershire (GB)

(21) Appl. No.: 11/658,712

(22) PCT Filed: Jul. 5, 2005
(86) PCT No.: PCT/GB2005/002633

§ 371 Date: Oct. 22, 2008

(30) Foreign Application Priority Data
Jul. 29, 2004 (GB) 0416925.6
Apr. 18, 2005 (GB) 0507788.8

(51) Int. Cl. F16K 11/00

(52) U.S. Cl. 137/625.4

(57) ABSTRACT

A mixing valve assembly (10) having a main housing (12) with a mixing chamber with hot (22) and cold (24) fluid inlets and an outlet (20) allowing hot and cold fluid to enter and exit the mixing chamber (14). The valve assembly also has a cold fluid bypass pipe to allow a proportion of cold fluid flowing into the valve housing to exit the housing via a cold fluid outlet (34) without entering the mixing chamber.

The present invention relates to a mixing valve and in particular to a mixing valve for use with water in an underfloor heating system.

Underfloor heating systems are generally constructed of a complex multi-layer network of pipes connected to a heat source (normally a boiler) of a building. Conventionally, in such a system the entire pipework network throughout the building is linked to a central distribution point, commonly known as a manifold. Heating fluid flows through this manifold to and from the heat source of the building.

All manifolds include a mixing valve which receives hot water from a boiler and mixes this hot water with cooler water from the returning loop of the pipe network. The hot and cool water mix within an internal chamber of the valve and then flows from the valve to a pump connected to the flow side of the system. A conventional heating system also requires pre-fabricated pipework to act as a bypass to allow a proportion of the cooler water to return to the boiler to be re-heated. This pre-fabricated pipework is connected to the mixing valve. The pipework and valve assembly are conveniently mounted on to a bracket which is then bolted or otherwise connected to a wall.

The present invention seeks to alleviate the aforementioned problems associated with conventional systems by providing an improved mixing valve that incorporates an in situ bypass. As such, a pre-fabricated bypass pipework is not required allowing the valve to be connected directly to a pump without the need for a separate bracket.

In one aspect, the invention provides a mixing valve comprising a main housing having an inner mixing chamber, the housing including a hot fluid inlet, a cold fluid inlet and an outlet linked to the inner chamber thereby to allow hot and cold fluid to flow into the mixing chamber to be mixed therein, and to flow from the mixing chamber via the outlet, the housing further including a cold fluid outlet linked directly to the cold fluid inlet to allow a proportion of cold fluid entering the valve housing through the cold fluid inlet to flow across the valve housing without entering the mixing chamber.

The invention will now be described by way of example with reference to the accompanying diagrammatic drawing, in which

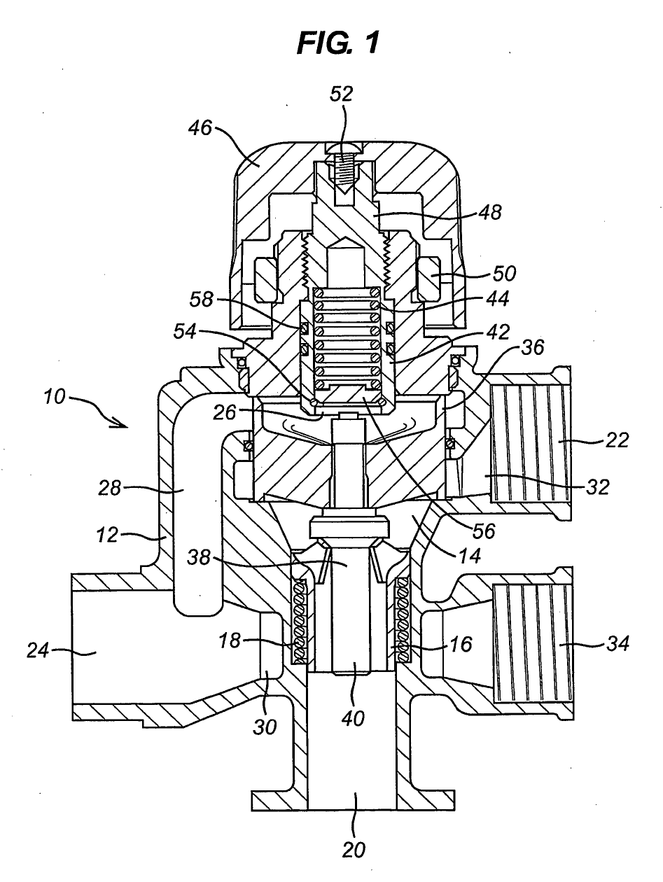

FIG. 1 is a side cross-section view of a mixing valve constructed in accordance with the present invention.

The figure shows a mixing valve 10 according to the present invention. The valve 10 comprises a main housing 12 having mixing chamber 14 which includes a mixing tube 16 retained within the mixing chamber 14 by a return spring 18. The bottom of the mixing chamber 14 communicates with a main fluid outlet 20.

The mixing valve 10 has hot and cold fluid inlets 22, 24 respectively. The hot inlet 22 extends into the mixing chamber 14 within the mixing valve 10. In use, when desired, hot fluid (for example water) flowing along the hot inlet pipe 22 is able to flow into the mixing chamber 14 via inlet opening 26.

The cold fluid inlet 24 extends into the housing 12 of the mixing valve 10 whereupon it divides into two cold fluid pipes 28, 30. The first cold fluid pipe 26 extends through the housing 12 and into the mixing chamber 14. In use, when desired, cold fluid (for example water) flowing along the first cold fluid pipe 28 is able to flow into the mixing chamber 14 via inlet opening 32.

The second pipe 30 extends through and across the housing 12, forming a cold fluid outlet 34 on the other side of mixing valve 10. Although not shown in the Figure, the second pipe 30 crosses the housing 12 either side of the mixing valve 10 allowing, in use, cold fluid travelling along the second pipe 30 to flow either side of the mixing valve 10 and out through the cold fluid outlet 34. The second pipe 30 therefore forms a bypass around the mixing chamber 14 allowing a proportion of cold fluid entering into housing 12 through the cold fluid inlet 24 to bypass the mixing chamber 14 entirely and simply flow out of the mixing pipe housing 12, via the cold fluid outlet 34, and to a boiler (not shown) for re-heating.

The rest of the cold fluid entering the housing 12 through the cold fluid inlet 24 flows along the first pipe -28 and, if required into the mixing chamber 14 whereupon it is mixed with hot fluid flowing into the mixing chamber 14 through the hot fluid inlet 22 and inlet opening 26.

The resultant fluid, now at a pre-determined temperature, is able to then flow out of the housing 10 through the main outlet 20 and around the system to provide the required heating to a floor under which the underfloor heating system is located.

The control mechanism for controlling the flow of hot and cold fluid into the mixing chamber 14 will now be described.

The control mechanism includes a main piston 36 and a thermostat 38. In a preferred embodiment, the piston 36 and thermostat 38 are formed as one-piece. One end 40 of the thermostat 38 extends into the mixing chamber 14 while the other end (the “top end”) abuts the bottom of a housing 42 which surrounds an overtravel spring 44. The piston 36 is lined with a wax/copper mixture which expands and contracts in response to temperature.

Figure shows the non-use situation where the piston 26 covers both inlet openings 26, 32 therefore closing the path of fluid travelling from either the hot pipe inlet 22 or the cold pipe inlet 28 to the mixing chamber 14.

In use, when the temperature of the fluid within the mixing chamber 14 is too high, the wax mixture expands causing the thermostat 38 to move upwardly against the overtravel spring housing 42. This, in turn, causes the piston 36 to lower thus opening inlet opening 26 to allow cold fluid from the cold fluid pipe 28 to enter the mixing chamber 14 thereby cooling the temperature within.

If, on the other hand, the fluid within the mixing chamber is too low, the wax mixture contracts causing the thermostat 38 to lower. The return spring 18 then forces the piston 36 upwardly thus opening inlet opening 32 to allow hot fluid from the hot fluid pipe 22 to enter the mixing chamber thereby heating the fluid within.

A control knob 46 is connected to the top of the housing 12 of the mixing valve 10 for manual control of the valve 10. The knob 46 is connected to the main housing 12 through a cap 48 which includes a locking cam 50 and the overtravel spring 44 and its housing 42. The knob 46 is attached to the cap 48 by a screw 52 received within an internal thread formed in the top of the cap 48. Rotation of the knob 46 causes compression of the overtravel spring 44 causing vertical movement of a piston 36 thereby opening one of the inlet openings 24, 32 to allow either hot or cold fluid to enter the mixing chamber 14, depending on the direction of rotation of, the knob 46.

The cap 46 is sealed within the housing 12 of the mixing valve 10 through a circlip 54, retainer 56 and a plurality of O-ring seals 58.

The above described embodiment has been given by way of example only, and the skilled reader will naturally appreciate that many variations could be made thereto without departing from the scope of the present invention.

1. A valve assembly comprising a main housing having an inner mixing chamber, the housing including a hot fluid inlet, a cold fluid inlet and an outlet to allow hot and cold fluid to enter the mixing chamber to be mixed therein and to flow from the mixing chamber via the outlet, the housing further including a cold fluid outlet linked to the cold fluid inlet to allow a proportion of cold fluid entering the valve housing through the cold fluid inlet to flow out of the cold fluid outlet without entering the mixing chamber.

2. A valve assembly according to claim 1, wherein the cold fluid inlet and cold fluid outlet are linked by a bypass conduit that extends across the valve assembly either side of the mixing chamber.

3. A valve assembly according to claim 1 or claim 2, further comprising a control mechanism for controlling the flow of hot and cold fluid into the mixing chamber via the hot and cold fluid inlets respectively.

4. A valve assembly according to claim 3, wherein the control mechanism comprises a piston assembly.

5. A valve assembly according to claim 4, wherein the piston is lined with a wax/copper mixture which expands and contracts in response to a change in temperature.

6. A valve assembly according to claim 4, wherein expansion or contraction of the mixture causes the piston to move between a first position whereby the hot fluid inlet is closed and the cold fluid inlet is open, a second position whereby the hot fluid inlet and cold fluid inlet are closed and a third position whereby the hot fluid inlet is open and the cold fluid inlet is open.

7. A valve assembly as hereinbefore described and referred to in the accompanying figure.
